(19) United States
(12) Patent Application Publication
(10) Pub. No.: US 2002/0079111 A1
(43) Pub. Date: Jun. 27, 2002

(54) Electric hammer

(76) Inventor: Vincent J. Camp, S.S.F, CA (US)

Correspondence Address: Vincent J. Camp, 115 Fir Ave. S.S.F, S.S.F, CA, 94080, US

(21) Appl. No.: 09/741,786

(22) Filed: Dec. 21, 2000

(51) Int. Cl. B25D 9/00

(52) U.S. Cl. 173/217; 173/117

(57) ABSTRACT

Electric Hammer with a cylindrical, slidable metallic hammer head, the hammer head retained by an electromagnetic coil and associated sleeve and compression spring thereby creating a solenoid type device, a hollow hammer shaped rigid plastic housing comprised of an upper half and a lower half including a hammer head holding portion, a shaft or handle portion and a lower battery holding portion, a capacitor, microprocessor and associated electronics mounted to a PC board to all located in said hollow handle portion, a rechargeable battery located in the lower handle portion, and a momentary on-off switch located on the handle portion so that the user can activate said solenoid hammer head by squeezing his or her fore finger. A preferred embodiment includes wherein said hammer head portion includes an inset magnet located on the front striking surface capable of temporarily retaining a nail made of ferrous material.

### BACKGROUND OF THE INVENTION

This invention relates generally to the field of hammers, and more particularly to an electric Hammer.

Hammers have been in use fro thousands of years. Typically, they have a handle which the user can grasp with one hand and a head that is fastened to the top of the handle. The head is usually made of very hard material such as cast metal. The user grasps the handle and swings the head of the hammer down on an object that is to be pounded. One typical use of a hammer is to drive metallic nails into softer material such as wood for the purpose of joining two pieces of wood together. In more recent times, electric nail guns have been developed to automatically drive a nail into a softer material. The user presses the entire gun device flat onto the surface to be nailed and pulls the trigger. A nail is electrically or pneumatically forced into the surface.

While nail guns have been proven to help speed up certain nailing jobs, there are other situations where nail guns are not appropriate. For example, when a person has to place a nail in an exact location the act of placing the entire nail gun over the location to be nailed creates a visual obstruction to precise placement. Additionally, nail guns usually only accept very small nails better known as brads. Generally electric nail guns can not handle larger or thicker nails. Finally, a user may be working on a project where the majority of the work can be accomplished by a traditional mechanical hammer, but when trying to hold and hammer a small nail, the user may become frustrated at trying to hold the nail in the proper place with his or her fingers and while trying to start the nail into the wood, end up hitting his or her fingers instead. In this situation it would be ideal if the user had a hammer that for the most part functioned as a traditional mechanical hammer, yet when the need arises, the user could receive a power assist to the hammer head thereby allowing the user to more easily start a small nail. The operation could be further improved if the proposed hammer head had an inset magnetic portion that could temporarily secure the head of a nail made of ferrous material.

### SUMMARY OF THE INVENTION

The primary object of the invention is to provide an electric hammer that can be hand held and used as an ordinary mechanical hammer, yet provide a powered assist when driving a nail or the like.

Other objects and advantages of the present invention will become apparent from the following descriptions, taken in connection with the accompanying drawings, wherein, by way of illustration and example, an embodiment of the present invention is disclosed.

Electric Hammer comprising: a cylindrical, slidable metallic hammer head, said hammer head retained by an electromagnetic coil and associated sleeve and compression spring thereby creating a solenoid type device, a hollow hammer shaped rigid plastic housing comprised of an upper half and a lower half including a hammer head holding portion, a shaft or handle portion and a lower battery holding portion, a capacitor, microprocessor and associated electronics mounted to a PC board to all located in said hollow handle portion, a rechargeable battery located in the lower handle portion, and a momentary on-off switch located on the handle portion so that the user can activate said solenoid hammer head by squeezing his or her fore finger.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a perspective view of a person holding the electric hammer of the present invention.

FIG. 2 is a plan view of the inside of said hammer with the head in the non activated position.

FIG. 2 is a partial plan view showing the head in the activated position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

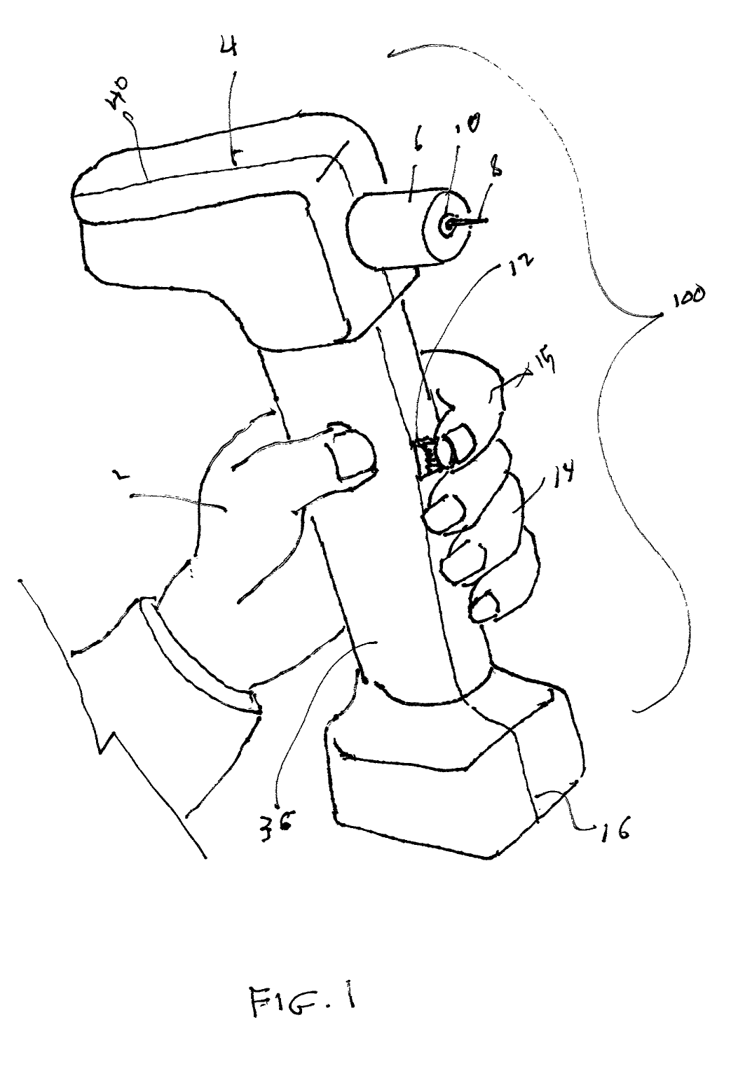

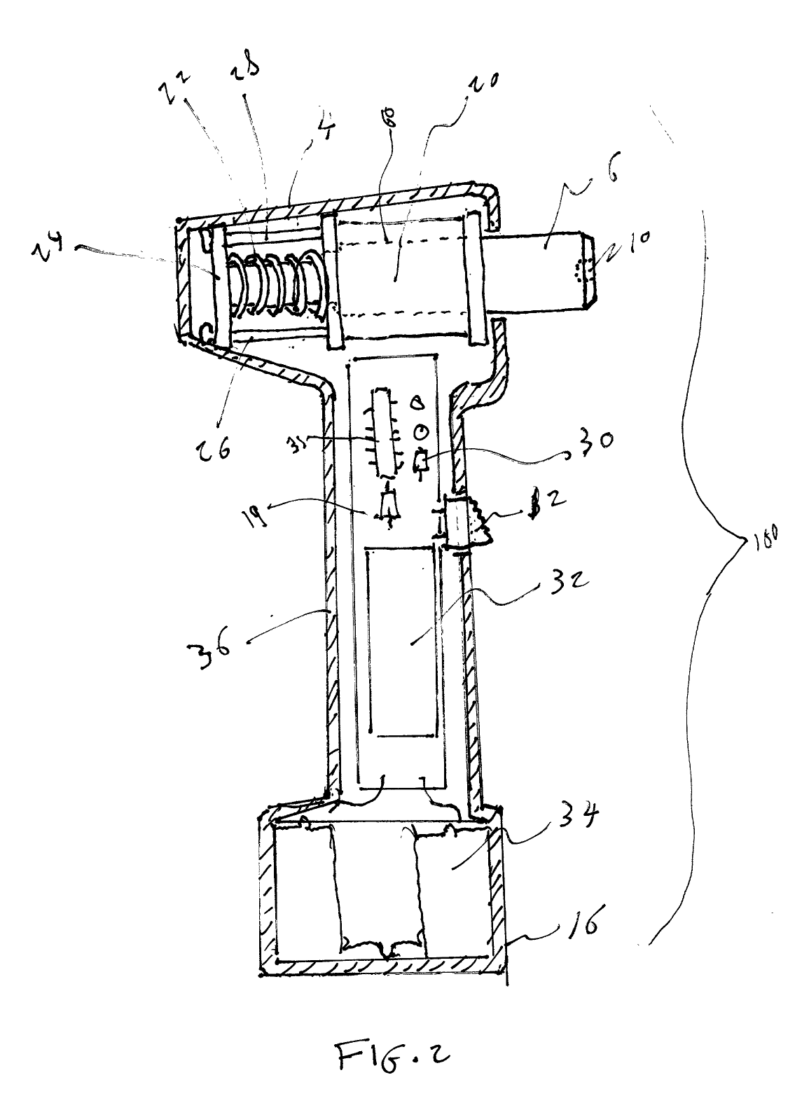

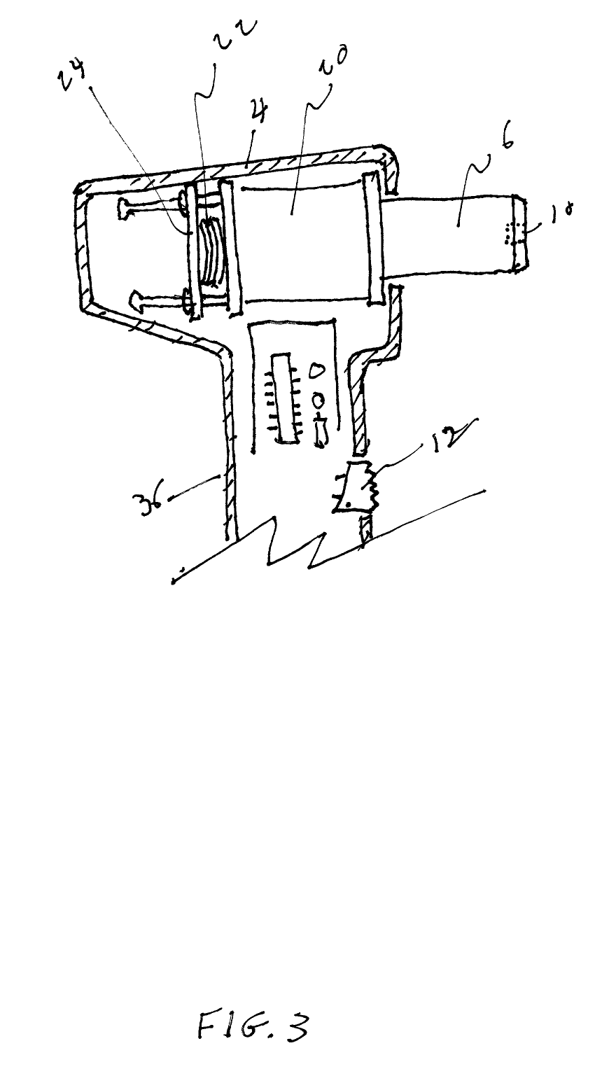

Referring now to FIG. 1 we see a perspective view of the electric hammer 100 of the present invention. A person grips the handle portion 36 in the same way he or she would grip a conventional hammer by wrapping the fingers 14 and thumb 2 around hammer handle 36. The user can swing the hammer 100 in the conventional mechanical way to drive a nail 8 or the like. The hammer of the present invention 100 has an integral molded hollow housing that is comprised of a head portion 4 a shaft portion 36 and a lower battery holding portion 16. The housing is molded in two halves as shown by parting line 40. The user can have electrically powered assistance when hammering in a nail by pressing momentary switch 12 with fore finger 15. This powered assist can help a person to start a small nail that otherwise may be difficult to hold thereby eliminating the discomfort of accidentally smashed fingers. Inset magnet 10 can further help hold ferrous nail 8 in place during the start of the nailing activity. FIG. 2 shows the inner construction of the hammer of the present invention 100. Integral plastic housing of hammer 100 can be seen as the head portion 4, the handle or shaft portion 36 and battery holding lower portion 16, sliding hammer head 6 is made of rigid metal and is held by solenoid coil 20 and continues out the rear of coil 20 to plate 24. Cylindrical hammer head 6 can be seen penetrating coil 20 by dotted line 60. Spring 22 keeps plate 24 in the outward position as shown. Retaining posts 26, 28 help align plate 24 and the flared ends of posts 26, 28 keep plate 24 from being pushed off the retaining posts 2, 28. PC board 19 retains microprocessor 31 and other support electronics 30 as well as capacitor 32. Capacitor 32 stores power from battery pack 34 so that a burst of power can be obtained to energize coil 20 causing hammer head 6 to rapidly propel itself forward. Microprocessor 31 controls the forward action as well as the release of power allowing spring 22 to carry hammer head 6 back to its resting position. Batteries 34 can be recharged in the standard way. FIG. 3 shows a partial plan view of hammer housing 4. In this view switch 12 is pressed in and hammer head 6 is propelled forward. Spring 22 is in its compressed position and plate 24 is in its pulled in position.

In the above described and illustrated way, a person can use the hammer of the present invention in the conventional way a person would use an ordinary mechanical hammer, however when the user needs a special assist in starting a nail, can press a switch to create an electrically powered hammer blow.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Electric Hammer comprising:
a cylindrical, slidable metallic hammer head;
said hammer head retained by an electromagnetic coil and associated sleeve and compression spring thereby creating a solenoid type device;
a hollow hammer shaped rigid plastic housing comprised of an upper half and a lower half including a hammer head holding portion, a shaft or handle portion and a lower battery holding portion;
a capacitor, microprocessor and associated electronics mounted to a PC board to all located in said hollow handle portion;
a rechargeable battery located in the lower handle portion; and
a momentary on-off switch located on the handle portion so that the user can activate said solenoid hammer head by squeezing his or her fore finger.

2. Electric Hammer as claimed in claim 1 wherein said hammer head portion includes an inset magnet located on the front striking surface capable of temporarily retaining a nail made of ferrous material.
